(19) United States
(12) Patent Application Publication
(10) Pub. No.: US 2016/0027250 A1
(43) Pub. Date: Jan. 28, 2016

(54) SYSTEM AND METHOD FOR ASSIGNMENT, HONORING AND TRANSFERING OF ELECTRONIC CREDIT, AWARDS OR POINTS FROM ELECTRONIC GAMES TO REAL GOODS OR SERVICE TRANSACTIONS

(71) Applicants: Luiz M. Franca-Neto, Sunnyvale, CA (US); Marcelo E. Peccin, Milpitas, CA (US)

(72) Inventors: Luiz M. Franca-Neto, Sunnyvale, CA (US); Marcelo E. Peccin, Milpitas, CA (US)

(21) Appl. No.: 14/339,437

(22) Filed: Jul. 23, 2014

(51) Int. Cl. G07F 17/32

(52) U.S. Cl. CPC G07F 17/3244

(57) ABSTRACT

A system, apparatus and method for generating and honoring awards, points or credits where ownership of each properly created and labeled award, point or credit is manifested and confirmed by the ability of a client to change specific secret content in pre-determined field assigned to said award, point or credit. Said ability is granted upon demonstration of knowledge of the current content of said pre-determined field. A system capable of purchases of good or services using awards, point or credits. A system supporting transfers, deposits and remittances of awards, points or credits with anonymity and convenience similar to ordinary cash. A system whose enabling client computational resources can be downloaded as a software application and can be operated under yearly subscription fee.

This patent application is related to a provisional application No. 61,857,518, “System and Method for Assignment, Honoring and Transferring of Electronic Credit, Awards, or Points from Electronic Games to Real Goods or Service Transactions”, submitted to the US PTO on Jul. 23, 2013, by the inventors of this current patent application.

This patent applications is also related to a patent application by one of the inventor of this current one under Ser. No. 13,947,067, “System and Method for Electronic Cash-Like Transactions”, filed with the US PTO on Jul. 21, 2013.

### BACKGROUND OF THE INVENTION

1. Field of the Invention

The invention relates generally to electronic credits or electronic awards in electronic games and their honoring in real goods or service transactions. More particularly it relates to how to ensure protection against electronic counterfeiting of credits or awards and how to ensure legitimate transfer of those credits and awards among individuals at the same time double honoring in real goods or service of the same electronic credit or award is safely precluded. This document also advances possible business models built upon this invention.

2. Background

Awards and total points earned in videogames recognize gamers' performance. In some videogames, awards and total points can be posted on online boards and become references for world wide competitive levels of players. Unfortunately, none of those awards or total points earned can be used to win to the player benefits in related or different services that might be of interest to gamers. E.g., a player who enjoys race videogames is not able to use his awards or total points earned to win actual race time in kart tracks places. The same player cannot in general use his awards and total points to offset the price of purchasing new videogames or new accessories. Moreover, a player cannot use those awards to offset for instance a plane ticket to visit a favorite place on the planet in which his (her) interest was prompted from his/her playing a videogame.

Therefore, there is a need to find a away to exploit synergies between related businesses through new features in videogames. In order to explore these synergies, awards and total points become bases to earn tradable credits. Players than can use those tradable credits for products or services of their interest. These good and services may be related to the videogame theme that generated the original awards and points, but doesn't need necessary to be so. For instance, credits or points can be directly purchased by a person using cash, and used for the same purpose gamers use those credits or points he or she earned from gaming performance. There is thus a need to desirably expand the benefits and allow those tradable credits to be used to purchase any product or service of interest to the players.

Moreover, there is a need to offer the means by which the tradable credits can circulate among players and be safely recognizable by the product and service sellers. Means to ensure credits are conveniently electronically carried and tradable is necessary. As it is also necessary to guarantee electronically traded credits are never spent twice.

It should also be appreciated that a solution for the generation of credits by awards or total points by videogames and the electronic solution to make those credits tradable can be extended to include generation of credits by other activities besides videogames. These tradable credits synergistically connect different industries, products and services which only need to agree to recognize and honor those credits.

It is also clear that a need to find a away to exploit the generation of credits by awards or total points can arise among currently unrelated industries. These industries may demonstrate to be of interest once the means to connect or trade their awards and credits are created. This also means that different industries may become interested in creating business associations with the objective of recognizing and honoring credits and awards granted by their members to users of videogames, players or clients in general of the industries in said association. All this will be highly beneficial to all the participant industries since there will be an augment of the pool of new individuals drawn to their services or products.

In this patent application, credits, awards and points are treated the same way when discussing their use. Their differences are mostly in name and context. Not in functionality, as the skilled in the art will immediately recognize.

### SUMMARY OF THE INVENTION

The invention is a system and method for electronic tradable credit transactions, which offers (1) validation of the credit used in the purchase or in offsetting the price of goods or services, and (2) precludes double spending of the same tradable credit and (3) offers untraceability and anonymity for the bearer of electronic credit whenever privacy is a concern. Computers, videogame consoles, mobile devices, cell phones and tablets can use the system in this invention and will be able to behave as electronic wallets for the user. By agreement between interested businesses, electronic credit is recognized and honored and allowed to be used in the complete or partial purchase of products or services from these interested businesses. Double spending of the same electronic credit is precluded by design of the system.

The invention described in this document in its variety of embodiments support (1), (2) and (3) by assigning ownership of each fraction of electronic award or point to whoever has the knowledge required to change an specific field of ownership appended to each sub-unit of electronic credit in circulation.

For a fuller understanding of the nature and advantages of the present invention, reference should be made clear by the following description together with the accompanying figures. The related and complementary details of the invention for aspects (1), (2) and (3) listed above will be described together in this provisional application. Examples of claims to this invention in its aspects (1), (2) and (3) are stated at the end of this document.

Even though embodiments of this invention that use mobile devices create a virtual wallet experience very similar to that of an ordinary cash wallet, the skilled in the art will recognize that other devices with adequate computational capabilities can be used with this invention without departing in spirit.

### BRIEF DESCRIPTION OF THE DRAWINGS

FIG. 1 shows the typical elements for awarding credits or points to a videogamer: the videogamer use his own console to contact the videogame maker or an industry association authority to present his performance in the videogame and receive his/her tradable awards or points.

FIG. 2 shows an example of anonymity in information exchange between a videogame maker or an industry association authority and a bearer of tradable awards or points. In this, an anonymous update of the bearer's ownership signature is processed. This exchange can be launched by the bearer at any time of the bearer's discretion and it is the means to confirm ownership in several instances and embodiment of the invention in this document.

FIG. 3 shows an example of information exchange between a person (A) and a videogame maker or an industry association authority (B) when A purchase good or service from B using A's tradable awards or points. B uses the network to check with its database or the industry association database the validity of A's tradable awards or points and requests a change in the ownership from A to B of those tradable awards or points. Upon receiving confirmation for the ownership change, B delivers the goods or services to A.

FIG. 4 shows an example of transfer of awards or points from a player to another.

### DETAILED DESCRIPTION OF THE INVENTION

In a patent application already filed Ser. No. 13,947,067, one of the authors described a “System and Method for Electronic Cash-like Transactions”. In that application, typical transactions based on currency, also referred to as transactions in cash in this document, it is important to (1) guarantee against counterfeiting and (2) guarantee the untraceability of the transaction and the anonymity of the bearer of cash, whenever privacy is required. These attributes (1) and (2) of transactions in cash are highly desirable attributes and differentiate those transactions in cash from the variety of other financial transactions involving the banking system or credit card operators.

In this current provisional application, the authors describe apparatus and methods to further the use and symbiotic growth of diverse industries by enabling an easy and convenient means by which videogamers can exchange or trade their awards and points achieved in their videogame plays. The skilled in the art will immediately recognize that the same apparatus and methods can be expanded to include several instances of the entertainment and recreational industry, or any service and goods industry with members willing to participate in an association to promote mutual growth.

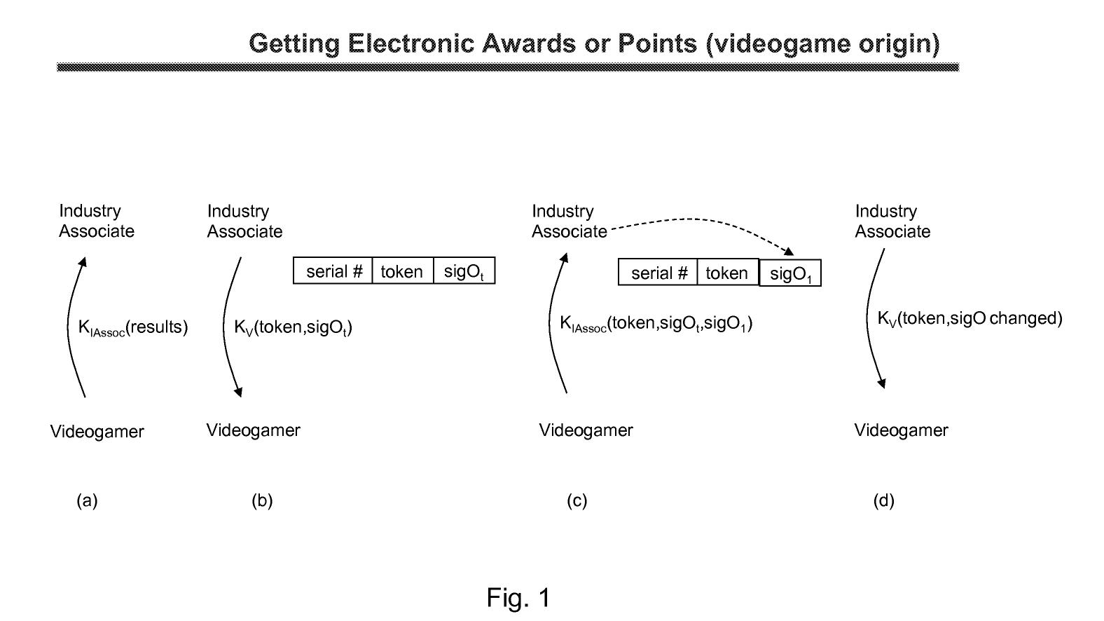

In an embodiment shown in FIG. 1, a videogamer reach pre-determined levels of performance and is rewarded with a tradable reward or pre-defined number of points. The videogamer's own console contact its maker and credit the videogamer's account with those awards or points by presenting his/her results using, for instance, a public key, K_{IAssoc}, of the industry asssociate he/she contacts. Ownership of those awards or points is defined in this invention as the ability to change an specific content field in the database where those awards or points are recorded. The videogame console has computational capabilities for supporting the secure communication to have the players' performance number converted into tradable awards or points according to the steps in FIG. 1.

The skilled in the art will recognize that in this invention the tradable credits, awards or points are treated in some instances as if they were electronic cash, and several details of the invention described below with the help of figures are discussed with concerns of security properly addressed.

Analogously to attending requirements of electronic money, each unit of credit, award or point in circulation, that is credit, award or point generated upon a videogamer's presentation of game performance or results, has its serial number, token and ownership fields contents kept in a database managed by the related industry association.

In FIG. 1, in an embodiment, only the token number and ownership field content of tradable award or point is known to the videogame player, i.e. the videogamer.

In FIG. 1, in an embodiment of this invention there is no anonymity in this specific exchange between the Industry Associate and the videogamer. That's because the industry association is the sole generator of those tradable award or points and a legitimate console is used to present the game performance or game results necessary to enable the videogamer to receive his/her tradable awards or points.

One of the innovations in this disclosure is the concept that legitimate ownership over tradable credits, awards or points is manifested or demonstrated by the ability of its owner to change a specific field in the award or point descriptive definition. This specific field is defined to contain an ownership signature (sigO). The industry association managing tradable awards or points according to this invention knows serial number, token and ownership content for each unit of award or point in circulation. In order to demonstrate or confirm ownership by changing the ownership content field of a unit of award or point in circulation, the presumed owner needs first to present the token number associated with each unit of his award or points and its current sigO value to a member of the industry association from whom the owner wants a product or service. Besides the industry association, sigO for a unit of award or money is only known to the owner of that unit of award or point. A request by a owner to change the current content of sigO, say sigO₁, to a new value, say sigO₂, is only performed by the industry association if it's presented with the current sigO of unit of award or point by the requestor. Response by the industry association attending the requestor's request confirms the validity of the unit of credit, award or point and its ownership by the requestor.

As will be seen double spending is precluded by the sequence of actions used in a embodiment of this invention to be described later in this document. Those actions are executed to complete a purchase of product or service from a member of the industry association.

It's important to observe that the owner of credits, awards or points can request change in the sigO content as many times and whenever he/she desires, and in fact he/she is recommended to frequently make such a change request to the industry association. Therefore, there will be no necessary correspondence between request for changes in sigO content and purchase, deposit, transfer or remittance of awards or points. This is important and is another innovative aspect of this invention that allows awards or points to be kept in circulation and to change hands untraceably in effect manifesting very similar attributes enjoyed in the use of ordinary cash, if the industry association so desire. The skilled in the art will recognize that the industry association is free to determine and enforce the validity of the tradable awards or points only to their named owner or anonymously to any bearer who can demonstrate ownership of said tradable awards or points in accordance with the secure procedure shown in FIG. 1.

Moreover, in one embodiment any client can at any time request anonymously the industry association to confirm the validity of his/her unit of tradable credit, awards or points.

Alternatively, the industry association can broadcast to all industry association members the means to locally check the validity of any tradable award or point in circulation. In one embodiment this is accomplished by the industry association broadcasting to all members in the system a key and the results obtained by encrypting the token of all tradable awards or points in circulation with that key. In such an embodiment, each member can encrypt with said key each token of the tradable awards or points in which it has an interest. This member will need only to see if the result produced by such an encryption matches any of the results broadcasted by said bank.

Assuming for discussion the videogamer is physically at his videogame console in FIG. 1, the information exchange between the Industry Associate and the videogamer's console can use a variety of proprietary connections, cribs or cables and the Internet. In an embodiment to provide security, the client communicate using the Industry Associate's public key (K_{IAssoc}). Upon presentation of game results and request of an amount of tradable award or points, the Industry Associate generate a serial number and a token for each unit of award or point to be dispensed to the videogamer's electronic wallet for award or points using one of the videogamers's public key (K_{A}). Serial numbers are attached to the smallest award or point unit. Accordingly, in FIG. 1a, the videogamer uses the Industry Associate's public key to identify himself/herself and request an amount of tradable award or points to be given to him in exchange for his game performance achievements. In FIG. 1b, the Industry Associate checks the legitimacy of the results in game performance presented by the videogamer, and using a videogamer's public key send him the token for each of the awards or point units in the amount requested by said videogamer. The token is a summary code generated by a one-way function from the serial number of each unit of tradable award or point created. The Industry Associate appends a temporary sigO value, sigOₜ, to each of the awards/points created for the videogamer, and also inform those contents to the videogamer using one of his/her's public key.

In FIG. 1c, the videogamer requests change in the content of sigO in each cent or suitable fraction of his/her just received tradable award/point from sigOₜ to a new content, sigO₁. In FIG. 1d, the Industry Associate confirms the change in the sigO content to sigO₁. This step settles the videogamer as the owner of each of those requested tradable awards/points, and its now in the powers of videogamer to relinquish ownership of any of those tradable awards/points by informing another person the sigO content of his tradable awards/points. This possible future relinquishing action by the videogamer may be carried over the Internet or any other adequate medium in a purchase or transfer by the videogamer as it will be described later in this document.

In another embodiment, the Industry Association can keep track of all the previous sigO content and instead of substituting its content with an updated value, the Industry Association can append the new sigO content to the older sigO content. This may help the Industry Association reconstruct the historical series of sigO content modification in case of unexpected disruptive events in the network.

The videogamer is also able to use his/her own computer, tablet or mobile phone to manage his awards or points. The videogamer, having being in control of his/her own videogame console can transfer his/her tradable awards or points to one of his mobile devices by a number of wired or wireless means the skilled in the art will recognize without departing from the spirit of this invention.

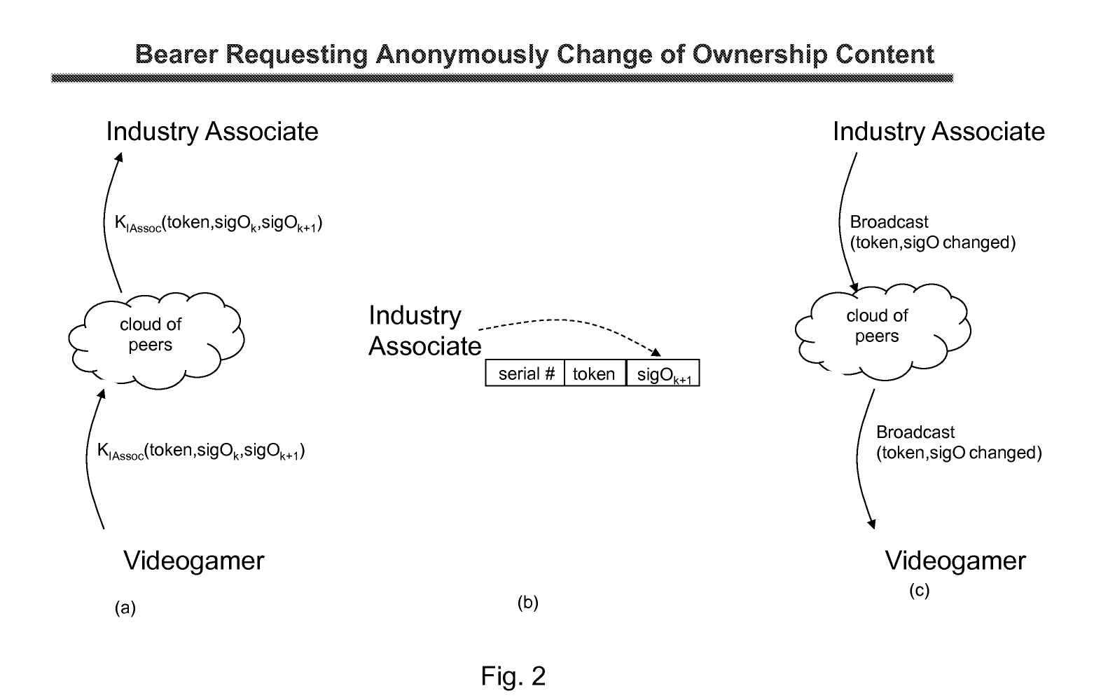

If the Industry Association so desires, the tradable credits/awards/points they generate can gain closer similarity to ordinary cash. The Industry Association can provide for untraceable tradable awards/points by making the confirmation of ownership be carried in communications peer to peer as indicated in FIG. 2.

The videogamer can use his mobile device to confirm ownership of his/her own tradable awards or points. As mentioned above, ownership is demonstrated by the capability of the owner to change the contents of a particular field in the records of his/her own tradable awards or points, records under the care of an authority representing the industry asssociation honoring those tradable credits, awards or points.

The skilled in the art will recognize the Industry Association can decide to allow any person to directly purchase tradable awards/points independently of having played any videogame. If such possibility is allowed, the tradable awards/points can become an instance of electronic cash, with the capability of stimulating further the expansion of economical activities for the members of said industry association. The skilled in the art will recognize that the Industry Association can also decide to allow owners of credits/awards/points to trade, donate or gift credits/awards/points among themselves, further simulating with those credits/awards/points features of trade normally associated with ordinary cash.

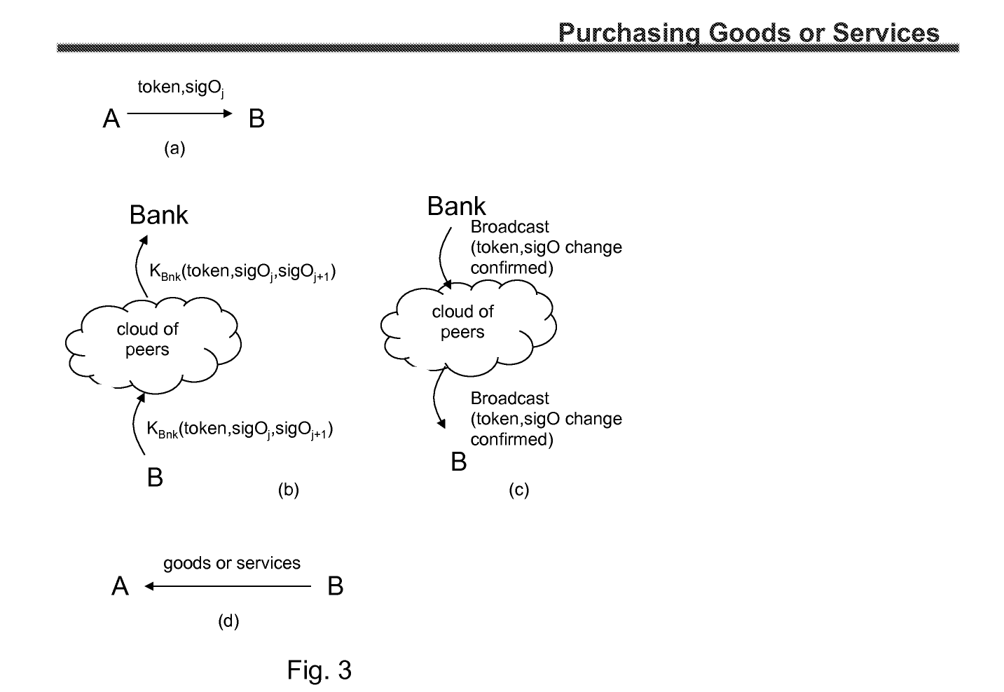

In FIG. 3, the videogamer (A) contact an industry associate member (B) for a product or service the videogamer is interested in and use his/her tradable awards/points to pay for this product or service. This can be the case for instance where the videogamer after playing a car race game decides to go to a cart race facility and try himself/herself on actual cart racing. But, this invention is not limited to such an example, and this invention can be used to pay for any other product or service from industries that are participants in an association and committed to honor those tradable awards/points owned by the videogamer.

FIG. 3 shows the sequence of actions in a purchase of goods or services. In an embodiment shown in FIG. 3a, the transaction between videogamer, here referred to as client A, is purchase from an industry associate, B. Industry member B is the recipient of a transfer of ownership of tradable awards or points from A. This transfer is effected by A transferring to B information about A's ownership of his/her tradable awards/points by means of transferring information of the awards/points' token and the content of ownership field (sigOj) from A to B.

In an embodiment, client A's mobile device may be in close proximity to industry member B's device or computer. Alternatively, B can make use of a fixed device running an application that can talk to client A's mobile device. Or, it still possible client A and B are physically away from each other and might be using the internet for their exchange. The skilled in the art will recognize still other alternative scenarios, including even pay cards, that can be considered without departing from the spirit of this invention.

In FIG. 3a, in an embodiment, client A uses public key of B to communicate the token number of the tradable awards/points he has and are necessary to purchase goods or services from B. Client A also informs the ownership content (sigO) associated with each cent of electronic money whose token number he/she informed B for the purchase. In an alternative embodiment clients A and B use a secure communication channel and client A communicates both token and ownership content without encryption. The skilled in the art will recognize other embodiments possible without departing from the spirit of the invention.

After receiving token and ownership content information from client A, B communicates and checks with the industry association database, represented by “Bank” in FIG. 3b, using an association's public key, and, in this example, making use of the cloud of peers, anonymously requests a industry association database computer to change the ownership content of each award/point B received from A for paying for goods or services.

If current ownership content (sigOⱼ, FIG. 3b) in the industry association's database is matched, the association computer broadcasts to all members confirmation of the change in ownership content for each token the association computer was requested to change. B may keep time stamps and repeat the anonymous request of change in ownership of the tradable awards/points B has just received from A with the intention of assuring the association is really confirming B's request of change of ownership and not an accidental effect of client A trying to double spend. Once B confirms he is the owner changing the ownership contents, B delivers the goods or services to A.

Because of this procedural construction, client A will not know the ownership content of any of the cents or suitable fraction of awards or points of after B successfully changed its ownership content, and double spending is therefore precluded. This is also one of the important innovations in this disclosure.

The skilled in the art will recognize that several alternative possible actions are available to B while requesting change of ownership for each of the tradable award/point B received from client A now in his (B's) possession. B may request the association to immediately convert it in cash and deposit in one of his (B's) accounts. B may also participate in another transaction with a different member of industry C and use the just received tradable awards/points now in his legitimate possession to pay for goods or services from C. In this way, the tradable awards/points can circulate in the economy, representing value to its owner in ways very similar to ordinary cash.

It will be straightforward to the skilled in the art that if B is an issuer of awards, points or credits, it may have access to the database where A's credits, point or awards reside. In such a case, if B is also to provide a product or a service to A, some of the steps can be simplified in the transaction and the figure of the “Bank” would be taken by B itself as well.

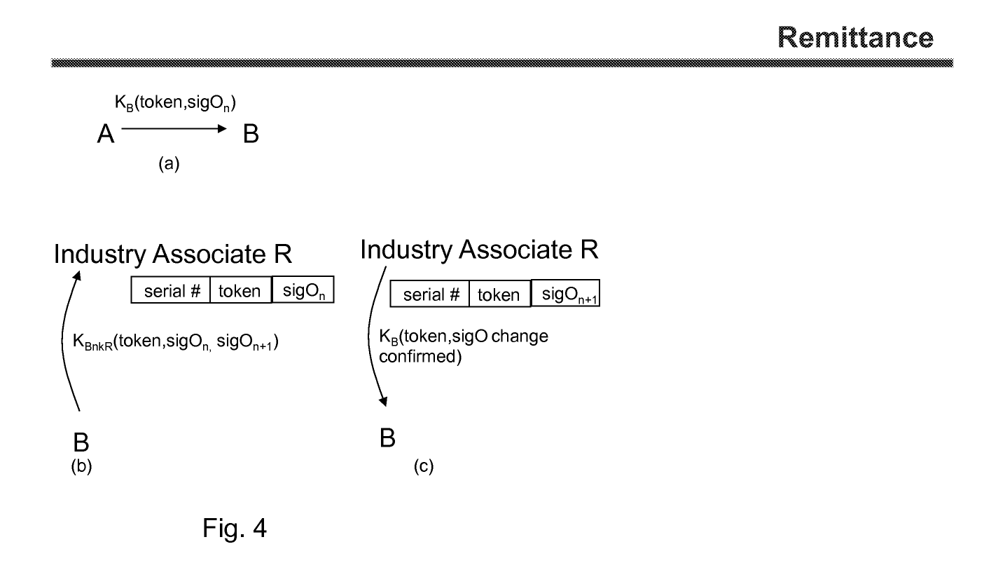

In FIG. 4 it's shown that a videogamer or anyone who owns tradable awards or points honored by a industry association of interest to them can transfer those tradable awards or points of his/her to anyone else whom he/she wants, if this is a transfer agreed upon or authorized by the Industry Association. In such a case, the transfer is processed with steps that ensure only one of the parts in this transfer will be able to demonstrate ownership of those tradable awards or points. The skilled in the art will recognize that even if the parts in this relationship want to conspire, those tradable awards or points will only be honored once by a member of the industry association setup to honor those tradable awards or points.

FIG. 4 shows an embodiment where a client A, who owns tradable awards/points, informs client B, who is to receive those tradable awards/points, of the token and ownership content of the tradable awards/points client A intends to transfer to B. Client A and client B might communicate through any suitable means, including through the internet. In a example of secure transfer, client A uses client B′s public key to inform token and ownership contents to client B (FIG. 4a). The skilled in the art will recognize that this procedure can be made to maintain anonymity of client A, who send the tradable awards/points, if A for instance make use of the cloud of peers.

Client B then proceeds contacting an industry associate, R, and requests a confirmation of token validity and change in ownership content (FIGS. 4b to 4c). R shares the database of the industry association where information on the electronic money in circulation resides and can confirm if the token presented by client B to R is legitimate and the ownership content provided by B matches the ownership content in the bank database.

After receiving confirmation from R (FIG. 4c), client B requests the ownership content to be changed to a value only he knows, which as discussed before settles the ownership of said tradable awards/points to belong to B.

### 2.0 Business Models

The invention in this disclosure describe the means to created tradable awards or points with functionality and operations very similarly to ordinary cash. As tablets and smart phones become progressive more popular, computing power is available at the hands of every person to provide him/her with the benefits and convenience of handling his/her tradable awards or points as it they were actual cash.

The skilled in the art will recognize that even though embodiments described in this document make reference to mobile devices, it will be also readily recognized that those transactions need not be exclusive to mobile devices. Purchases and transfers can be made with laptop or desktop computers or even dedicated hardware for the handling of tradable awards or points according to this invention.

Even though the tradable credit, awards and points were initially inspired by the desire to provide a means to videogamers to extend their videogame experience, this invention is not limited to any single industry. In actuality, a diverse number of industries can benefit from this invention in a variety of operations that augments their opportunity to provide products and services. Tradable awards or points as presented in this application stimulate demand for goods and services benefiting all the industries associated to honor them.

The Industry Association, or equivalent entity, managing the market of the tradable credits/awards/points in this invention may generate revenue by subscription fee included in the price of the videogames, or percentage from some transactions with those credits/awards/points, or by annual subscription to the required software and encryption algorithms necessary for any person or business to operate in the tradable market of credit/awards/points as described in this patent application.

It will be clear to the skilled in the art that an embodiment of this invention can be constructed without departing from the spirit of the invention, where tradable awards, points or credits, here mentioned without distinction, are freely transferable from one individual to another. It is also clear that the industries in association to honor those awards, points or credits are at liberty to decide to impose special restrictions, temporary or permanent on the transfer of those tradable awards, points or credits. For instance, those tradable awards, points or credits might be made non-transferable and only the individual who earned those awards, points or credits is allowed to purchase product or service with those awards, points or credits.

This invention will be covered by claims, and the skilled in the art will recognize without the spirit that this invention encompasses an electronic system for honoring awards, points or credits, where transactions different from the generation of awards, points or credits can be made by a client either identifying himself/herself or anonymously.

This invention also encompass an electronic system for honoring awards, points or credits, where a client choosing to remain anonymous use a cloud of peers to forward his requests or transfer of ownership of awards, credits or points.

This invention also encompass an electronic system for honoring awards, points or credits, where awards, points or credits extinguish when used to purchase goods or services.

This invention also encompass an electronic system for honoring awards, points or credits, where an application is downloaded to a videogame console, computer, tablet, smartphone or mobile device to support the transactions with awards, points or credits for a client.

This invention also encompass an electronic system for honoring awards, points or credits, where a client subscribe to the award, credit and point service by purchasing a videogame or paying for a subscription fee with a time to expire .

This invention also encompass an electronic system for honoring awards, points or credits, where a client pay the subscription fee to awards, points or credits service to download the application to support the transactions supported by said electronic system.

This invention also encompass an electronic system for honoring awards, points or credits, where said subscription fee to the electronic money service includes insurance against fraud.

This invention also encompass a method for creating and honoring awards, points or credits, where ownership of awards, points or credits is assigned to any one of the clients in the system who can change an specific secret content, called ownership content, associated with said awards, points or credits.

This invention also encompass a method for creating and honoring awards, where to change the specific secret content, the client requesting the change needs to present the current content and inform the new content.

This invention also encompass a method for creating and honoring awards, where to change said specific content a client send the request through at least one peer.

This invention also encompass a method for creating and honoring awards, where to change said specific content a client send the request to a pre-determined forwarding node.

This invention also encompass a method for creating and honoring awards, where a representative of the industry using said method keeps information on each cent or suitable fraction of his/her awards, points or credits and its corresponding specific content, which is used to determine ownership.

This invention also encompass a method for creating and honoring awards, where clients request a representative of the industry using said method to change ownership content while also presenting to said representative with the current content of said ownership content.

This invention also encompass a method for creating and honoring awards, where clients make request to change ownership and communicate it to a representative of the industry using said method, encrypting his/her request using one of said representative's public key.

This invention also encompass a method for creating and honoring awards, where the client request goes to at least one forwarding part before reaching the representative which manages the awards, points or credits circulation.

This invention also encompass a method for creating and honoring awards, where the representative responsible for managing the circulation of awards, points or credits responds confirming change of ownership content by broadcasting to all clients

This invention also encompass a method for creating and honoring awards, where a client uses awards, points or credits for purchase of goods or services

This invention also encompass a method for creating and honoring awards, where client purchase goods or service by transferring to a seller of good or services information on the ownership content of the awards, points or credits said client is giving said seller in exchange for said goods or services.

This invention also encompass a method for creating and honoring awards, where said seller of goods or services only accepts awards, points or credits after being able to confirm said awards, points or credits are valid by confirming said seller can change the ownership content of said awards, points or credits.

This invention also encompass a method for creating and honoring awards, where said client can make said request anonymously.

This invention also encompass a method for creating and honoring awards, where a first client can transfer ownership of his electronic money to a second client by communicating to said second client information about numbers and ownership content of said electronic money. Transfer is completed when second client changes the ownership content

This invention also encompass a method for creating and honoring awards, where a part managing the circulation of awards, points or credits manages the awards, points or credits it generates at request of a client and also manages changes in ownership content of said awards, points or credits generated.

This invention also encompass a method for creating and honoring awards, where said part managing the circulation of awards, points or credits is queried by the clients about the validation of the numbers of an electronic money.

This invention also encompass a method for creating and honoring awards, where said part managing the circulation of awards, points or credits is requested to change the ownership content upon presentation by a client of current ownership content.

This invention also encompass a method for creating and honoring awards, where for each cent or suitable fraction of award, point or credit generated by an authorized part using said method, said part broadcasts a key and the results of each of the serial numbers of awards, points or credits to the clients using the method.

This invention also encompass a method for creating and honoring awards, where a receptor of electronic award, point or credit can check its validity by either requesting confirmation for the award, point or credit serial numbers from a part which generates award, point or credit using the method or by encrypting said electronic numbers with a key broadcast by said part and checking if the results are among the results said part broadcasted.

This invention also encompass a method for creating and honoring awards, where awards, points or credits are kept in circulation changing owners and used for multiple transactions

This invention also encompass a method for creating and honoring awards, where transactions different from the generation of electronic money can be made by a client either identifying himself/herself or anonymously.

This invention also encompass a method for creating and honoring awards, where a client choosing to remain anonymous use a cloud of peers to forward his requests or transfer of ownership of award, point or credit.

1. An apparatus and method to securely generate electronic awards, points or credits based on videogame performance. Said awards, points or credits are tradable for other products or services by secure means.

2. the apparatus and method of claim 1, where ownership of electronic awards, points or credit is assigned to any one of the clients in the system who can change an specific secret content, called ownership content, associated with said electronic awards, points or credit.

3. the apparatus and method of claim 2, where to change the specific secret content, the client requesting the change needs to present the current content and inform the new content.

4. the apparatus and method of claim 2, where to change said specific content the client send the request through at least one peer.

5. the apparatus and method of claim 2, where to change said specific content the client send the request to a pre-determined forwarding node.

6. the apparatus and method of claim 2, where a participant keeps information on each cent or suitable fraction of electronic awards, points or credit and its corresponding specific content, which is used to determine ownership.

7. the apparatus and method of claim 2, where clients request a representative of the industry association providing services and products redeemed by said awards, points or credits to change ownership content while also presenting to said participant with the current content of said ownership content.

8. the apparatus and method of claim 2, where clients make request to change ownership of awards, points or credits, and communicate it to a representative of the industry association honoring said awards, points or credits, encrypting his/her request using one of the said representative's public key.

9. the electronic system for honoring awards, points or credits, where user who have awards, points or credits are named clients and can make requests to a representative of the industry association honoring said awards, points or credits to change ownership content of the client's said awards, points or credits, said requests go directly to a representative of the industry honoring said awards, points or credits or go through at least one forwarding part in the system before reaching a representative of the industry honoring said awards, points or credits.

10. the electronic system for honoring awards, points or credits of claim 9, where the representative of the industry honoring said awards, points or credits responds to a request to change of ownership confirming the change of ownership content by broadcasting to all owners of awards, points or credits in the system.

11. the electronic system for honoring awards, points or credits of claim 9, where a owner of awards, points or credits uses his awards, points or credits for purchase of goods or services from industries in the association which honors said awards, points or credits.

12. electronic system for honoring awards, points or credits of claim 9, where the purchase goods or service using awards, points or credits is performed by transferring to a seller of said good or services information on the ownership content of suitable amount of awards, points or credits to a seller in exchange for said goods or services.

13. electronic system for honoring awards, points or credits of claim 12, where said seller of goods or services only accepts the awards, points or credits after being able to confirm said awards, points or credits are valid and that said seller can change the ownership content of said awards, points or credits.

14. electronic system for honoring awards, points or credits of claim 9, where a first client can transfer ownership of his awards, points or credits to a second client by communicating to said second client information about numbers and ownership content of said awards, points or credits. Transfer is completed when second client changes the ownership content of said awards, points or credits

15. electronic system for honoring awards, points or credits of claim 9, where a part managing the circulation of awards, points or credits manages the awards, credits and points it generates at request of a client who earned those awards, point or credits through performance on a videogame, said part also manages changes in ownership content of said awards, points or credits.

16. the electronic system for honoring awards, points or credits of claim 15, where said part managing the circulation of awards, points or credits is queried by the clients about the validation of the numbers of awards, points or credits.

17. the electronic system for honoring awards, points or credits of claim 15, where said part managing the circulation of awards, points or credits is requested to change the ownership content upon presentation by a client of current ownership content.

18. the electronic system for honoring awards, points or credits of claim 9, where for each award, point or credit generated by an authorized part in the system, said part broadcasts a key and the results of each of the serial numbers of award, point or credit to the clients in the system.

19. the electronic system for honoring awards, points or credits of claim 18, where a receptor of award, point or credit can check its validity by either requesting confirmation for the electronic money numbers from an authorized part which generates awards, points or credits in the system or by encrypting said electronic numbers with said key and checking if the results are among the results said part broadcasted as being results of valid awards, points or credits.

20. the electronic system for honoring awards, points or credits of claim 9, where awards, credits and points can be kept in circulation changing owners and used for multiple transactions
